(19) United States
(12) Patent Application Publication
(10) Pub. No.: US 2022/0187518 A1
(43) Pub. Date: Jun. 16, 2022

(54) WAVELENGTH CONVERSION MEMBER, BACKLIGHT UNIT, AND IMAGE DISPLAY DEVICE

(71) Applicant: SHOWA DENKO MATERIALS CO., LTD., Chiyoda-ku, Tokyo (JP)

(72) Inventors: Yoshitaka KATSUTA, Chiyoda-ku, Tokyo (JP); Tomoyuki NAKAMURA, Chiyoda-ku, Tokyo (JP); Futoshi OIKAWA, Chiyoda-ku, Tokyo (JP); Mayumi SATO, Chiyoda-ku, Tokyo (JP); Katsuyoshi SAKAMOTO, Chiyoda-ku, Tokyo (JP); Yuma YOSHIDA, Chiyoda-ku, Tokyo (JP); Daisuke OTSUKI, Chiyoda-ku, Tokyo (JP); Kunihiro KIRIGAYA, Chiyoda-ku, Tokyo (JP)

(21) Appl. No.: 17/437,048

(22) PCT Filed: Apr. 10, 2019
(86) PCT No.: PCT/JP2019/015688

§ 371 Date: Sep. 8, 2021

(51) Int. Cl. G02B 5/20; G02B 5/02; G02B 1/00; G02F 1/13357; G02F 1/1335

(52) U.S. Cl. CPC G02B 5/206; G02B 5/0242; G02F 1/133514; G02F 1/133615; G02F 1/133504; G02B 1/002

(57) ABSTRACT

A wavelength conversion member, comprising a wavelength conversion layer that comprises a phosphor and a light scattering material, and satisfying at least one of the following (1) or (2): (1) the wavelength conversion member has a diffusion transmittance of 50% or less and the wavelength conversion layer having a thickness of 100 μm or less; or (2) a content of the light scattering material in a total wavelength conversion layer is 2.0% by mass or more.

### TECHNICAL FIELD

The present disclosure relates to a wavelength conversion member, a backlight unit, and an image display device.

### BACKGROUND ART

Improvement in color reproducibility of a display has been increasingly desired in the field of image display devices such as liquid crystal display devices.

As a means for improving the color reproducibility, a wavelength conversion member including a quantum dot phosphor, as described in Japanese National Phase Publication No. 2013-544018 and International Publication No. 2016/052625, is attracting attention.

A wavelength conversion member including a phosphor is installed in a backlight unit of an image display device, for example. When a wavelength conversion member includes a phosphor that emits red light and a phosphor that emits green light, and is irradiated with blue light as excitation light, white light is obtained from red light and green light emitted from the phosphors and blue light passing through the wavelength conversion member.

The NTSC (National Television System Committee) ratio, indicating a degree of color reproducibility of displays, has increased to 100%, from conventionally being 72%, due to the development of wavelength conversion members including a phosphor.

### SUMMARY OF THE INVENTION

### Problem to be Solved by the Invention

Since phosphors are rather expensive materials, it is desired to achieve a satisfactory wavelength conversion effect with smaller amounts of the phosphors from the viewpoint of production cost reduction for image display devices. In addition, quantum dot phosphors, which are currently used as phosphors, commonly include cadmium (Cd). Meanwhile, movement toward regulating the amount of heavy metals used in electronic devices has been spreading worldwide. Accordingly, reduction in the amount of quantum dot phosphors required to achieve a favorable color balance has been desired.

In view of the aforementioned circumstances, the present disclosure aims to provide a wavelength conversion member that can achieve a desired color tone with suppressed amounts of phosphors; and a backlight unit and an image display device including the wavelength conversion member.

### Means for Solving the Problem

The means for solving the problem as described above includes the following embodiments.

<1> A wavelength conversion member, comprising a wavelength conversion layer that comprises a phosphor and a light scattering material, the wavelength conversion member having a diffusion transmittance of 50% or less, and the wavelength conversion layer having a thickness of 100 μm or less.

<2> The wavelength conversion member according to <1>, wherein a ratio of the diffusion transmittance with respect to a total light transmittance is 80% or more.

<3> The wavelength conversion member according to <1> or <2>, wherein the light scattering material comprises titanium oxide.

<4> The wavelength conversion member according to any one of <1> to <3>, wherein a content of the light scattering material in the wavelength conversion layer is 2.0% by mass or more.

<5> The wavelength conversion member according to any one of <1> to <4>, further comprising a resin cured product.

<6> A wavelength conversion member, comprising a wavelength conversion layer that comprises a phosphor and a light scattering material, a content of the light scattering material in a total wavelength conversion layer being 2.0% by mass or more.

<7> The wavelength conversion member according to <6>, wherein the light scattering material comprises titanium oxide.

<8> The wavelength conversion member according to <6> or <7>, having a ratio of a diffusion transmittance with respect to a total light transmittance of 80% or more.

<9> A backlight unit, comprising the wavelength conversion member according to any one of <1> to <8>, and a light source.

<10> An image display device, comprising the backlight unit according to <9>.

### Effect of the Invention

According to the present disclosure, a wavelength conversion member that can achieve a desired color tone with suppressed amounts of phosphors; and a backlight unit and an image display device including the wavelength conversion member are provided.

### BRIEF DESCRIPTION OF THE DRAWINGS

FIG. 1 is a schematic view illustrating an exemplary configuration of a wavelength conversion member.

FIG. 2 is a schematic view illustrating an exemplary configuration of a backlight unit.

FIG. 3 is a schematic view illustrating an exemplary configuration of a liquid crystal image display device.

### EMBODIMENTS FOR IMPLEMENTING THE INVENTION

In the following, embodiments for implementing the invention are explained. However, the invention is not limited to these embodiments. The elements of the embodiments (including steps) are not essential, unless otherwise stated. The numbers and the ranges thereof do not limit the invention as well.

In the present disclosure, the numerical range represented by “from A to B” includes A and B as a minimum value and a maximum value, respectively.

In the present disclosure, when numerical ranges are described in a stepwise manner, the values of the upper or lower limit of each numerical range may be substituted by the values of the upper or lower limit of the other numerical range, or may be substituted by the values described in the Examples.

In the present disclosure, each component may include more than one kinds of substances. When there are more than one kind of substances corresponding to a component of a composition, the content of the component refers to a total content of the substances, unless otherwise stated.

In the present disclosure, each component may include more than one kind of particles. When there are more than one kind of particles corresponding to a component of a composition, the particle size of the component refers to a particle size of a mixture of the more than one kind of particles.

In the present disclosure, the “layer” or “film” includes a state in which the layer or the film is formed over the entire region and a state in which the layer or the film is formed at a portion of the region, when the region is observed at which the layer or the film exists.

In the present disclosure, the “laminate” refers to disposing a layer on another layer, and the layers may be bonded together or may be detachable from each other.

In the present disclosure, the “(meth)acrylate” refers to at least one of acrylate or methacrylate, the “(meth)allyl” refers to at least one of allyl or methallyl, the “(meth)acrylic” refers to at least one of acrylic or methacrylic, and the “(meth)acryloyl” refers to at least one of acryloyl or methacryloyl.

In the present disclosure, when an embodiment is explained by referring to a drawing, the configuration of the embodiment is not limited to a configuration illustrated in the drawing. The size of the members illustrated in the drawing is conceptual, and the relative relationship in size among the members is not limited thereto. In the drawing, the same symbol may be given to the members having the substantially same function, and overlapping explanations may be omitted.

<<Wavelength Conversion Member (First Embodiment)>>

The wavelength conversion member according to the first embodiment is a wavelength conversion member, comprising a wavelength conversion layer that comprises a phosphor and a light scattering material, the wavelength conversion member having a diffusion transmittance of 50% or less, and the wavelength conversion layer having a thickness of 100 μm or less.

The wavelength conversion member satisfying the above conditions can achieve a desired color tone with suppressed amounts of phosphors. The reason for this is not clear, but is assumed to be the following.

The wavelength conversion member converts a part of the incident light (for example, blue light) to light with different wavelengths (for example, red light and green light), whereby light with a desired color tone (for example, white light) is obtained. Accordingly, in order to achieve a desired color tone without increasing the amount of a phosphor, it is effective to enhance the efficiency for wavelength conversion per unit amount of a phosphor.

In the wavelength conversion member according to the present embodiment, the wavelength conversion efficiency per unit amount of a phosphor is enhanced by including a light scattering material in the wavelength conversion layer, together with a phosphor. Further, the wavelength conversion member has a diffusion transmittance of 50% or less. A wavelength conversion member having a diffusion transmittance of 50% or less includes a relatively large amount of the light scattering material. This acts as a factor for a further enhancement in the wavelength conversion efficiency per unit amount of a phosphor, and for a reduction in the amount of a phosphor that is necessary to achieve a desired color tone. In addition, by regulating a thickness of the wavelength conversion member to be 100 μm or less, it is possible to reduce the amount of a phosphor per unit area. As a result, a desired color tone can be achieved while suppressing the amount of a phosphor.

From the viewpoint of improving the wavelength conversion efficiency by a phosphor while maintaining the brightness, the wavelength conversion member preferably has a diffusion transmittance of from 20% to 50%, more preferably from 30% to 50%.

From the viewpoint of improving the wavelength conversion efficiency by a phosphor, the wavelength conversion member preferably has a ratio of the diffusion transmittance with respect to the total light transmittance (haze) of 80% or more, more preferably 90% or more, further preferably 95% or more.

In the present disclosure, the total light transmittance (TT) and the diffusion transmittance (DIF) of the wavelength conversion member are measured by a method according to JIS K 7136: 2000. The haze is a value calculated by the following equation: haze (%)=(DIF/TT)×100.

The method for controlling the total light transmittance and the diffusion transmittance of the wavelength conversion member is not particularly limited. For example, the total light transmittance and the diffusion transmittance may be controlled by the amount or the type of a light scattering material included in the wavelength conversion layer, the thickness of the wavelength conversion layer, and the like.

In an embodiment of the wavelength conversion member, the wavelength conversion layer may include a light scattering material in an amount of 2.0% by mass or more in the total wavelength conversion layer, or the wavelength conversion layer may include titanium oxide as a light scattering material.

The thickness of the wavelength conversion layer is not particularly limited, as long as it is 100 μm or less. For example, the thickness of the wavelength conversion layer is preferably from 40 μm to 100 μm, more preferably from 60 μm to 100 μm, further preferably from 60 μm to 90 μm. When the thickness of the wavelength conversion layer is 40 μm or more, the wavelength conversion efficiency tends to further improve. When the wavelength conversion member is applied to a backlight unit as described later, having a wavelength conversion layer with a thickness of 100 μm or less is also advantageous in that the thickness of the backlight unit can be reduced. The thickness of the wavelength conversion layer can be measured with a micrometer, for example. When the thickness of the wavelength conversion layer is not uniform, an average thickness (an arithmetic average value of the values measured at arbitrary three sites) is regarded as the thickness of the wavelength conversion layer.

The wavelength conversion member may consist only of a wavelength conversion layer, or may have a member other than a wavelength conversion layer.

For example, the wavelength conversion member may have a wavelength conversion layer and a covering material disposed at one or both surfaces of the wavelength conversion layer. The wavelength conversion member may have one wavelength conversion layer or two wavelength conversion layers. When the wavelength conversion member have two or more wavelength conversion layers, the average thickness of the wavelength conversion layer as mentioned above refers to an average thickness of the total wavelength conversion layers.

When the wavelength conversion member has a covering material disposed at one or both surfaces of the wavelength conversion layer, the wavelength conversion member tends to achieve improved handleability or improved barrier properties with respect to water, oxygen or the like.

The thickness of the covering material is preferably from 20 μm to 150 μm, more preferably from 20 μm to 100 μm, further preferably from 20 μm to 80 μm, for example. The thickness of the covering material can be measured with a micrometer, for example. When the thickness of the covering material is not uniform, an average thickness (an arithmetic average value of the values measured at arbitrary three sites) is regarded as the thickness of the covering material.

The material for the covering material is not particularly limited, and may be polyester such as polyethylene terephthalate (PET) or polyethylene naphthalate (PEN), polyolefin such as polyethylene (PE) or polypropylene (PP), polyamide such as nylon, and ethylene-vinyl alcohol copolymer (EVOH). From the viewpoint of availability, the material for the covering material is preferably polyethylene terephthalate.

The covering material may be a barrier film, i.e., a covering material having a barrier layer for improving barrier properties. Examples of the barrier layer include an inorganic layer including an inorganic substance such as alumina or silica.

From the viewpoint of suppressing a reduction in the wavelength conversion efficiency of a phosphor, the covering material preferably has a barrier property with respect to at least one of oxygen or water, more preferably has a barrier property with respect to oxygen and water. The type of the covering material having a barrier property with respect to at least one of oxygen or water is not particularly limited, and examples thereof include a barrier film having an inorganic layer.

The covering material preferably has an oxygen transmission rate of 1.0 mL/(m²·24 h·atm) or less, more preferably 0.8 mL/(m²·24 h·atm), further preferably 0.6 mL/(m²·24 h·atm) or less, for example.

The oxygen transmission rate of the covering material may be measured by using an oxygen transmission rate measurement device (for example, OX-TRAN, MOCON, Inc.) at 23° C. and a relative humidity of 90%.

The covering material preferably has a water vapor transmission rate of 1×10⁰ g/(m²·24 h) or less, more preferably 8×10⁻¹ g/(m²·24 h) or less, further preferably 6×10⁻¹ g/(m²·24 h) or less, for example.

The water vapor transmission rate of the covering material may be measured by using a water vapor transmission rate measurement device (for example, AQUATRAN, MOCON, Inc.) at 40° C. and a relative humidity of 100%.

(Phosphor)

The type of the phosphor included in the wavelength conversion layer is not particularly limited, and examples thereof include an organic phosphor and an inorganic phosphor.

Examples of the organic phosphor include naphthalimide compounds and perylene compounds.

Examples of the inorganic phosphor include inorganic phosphors that emit red light, such as Y₃O₃:Eu, YVO₄:Eu, Y₂O₂:Eu, 3.5MgO.0.5MgF₂, GeO₂:Mn and (Y.Cd)BO₂:Eu; inorganic phosphors that emit green light, such as ZnS:Cu.Al, (Zn.Cd)S:Cu.Al, ZnS:Cu.Au.Al, Zn₂SiO₄:Mn, ZnSiO₄:Mn, ZnS:Ag.Cu, (Zn.Cd)S:Cu, ZnS:Cu, GdOS:Tb, LaOS:Tb, YSiO₄:Ce.Tb, ZnGeO₄:Mn, GeMgAlO:Tb, SrGaS:Eu²⁺, ZnS:Cu.Co, MgO.nB₂O₃:Ge.Tb, LaOBr:Tb.Tm and La₂O₂S:Tb; inorganic phosphors that emit blue light, such as ZnS:Ag, GaWO₄, Y₂SiO₆:Ce, ZnS:Ag.Ga.Cl, Ca₂B₄OCl:Eu²⁺ and BaMgAl₄O₃:Eu²⁺; and quantum dot phosphors.

From the viewpoint of color reproducibility of an image display device, the wavelength conversion member preferably includes a quantum dot phosphor. The type of the quantum dot phosphor is not particularly limited, and examples thereof include particles containing at least one selected from the group consisting of II-VI compounds, III-V compounds, IV-VI compounds and IV compounds. From the viewpoint of light emission efficiency, the quantum dot phosphor preferably includes a compound that includes at least one of Cd or In.

Specific examples of the II-VI compound include CdSe, CdTe, CdS, ZnS, ZnSe, ZnTe, ZnO, HgS, HgSe, HgTe, CdSeS, CdSeTe, CdSTe, ZnSeS, ZnSeTe, ZnSTe, HgSeS, HgSeTe, HgSTe, CdZnS, CdZnSe, CdZnTe, CdHgS, CdHgSe, CdHgTe, HgZnS, HgZnSe, HgZnTe, CdZnSeS, CdZnSeTe, CdZnSTe, CdHgSeS, CdHgSeTe, CdHgSTe, HgZnSeS, HgZnSeTe and HgZnSTe.

Specific examples of the III-V compounds include GaN, GaP, GaAs, GaSb, AlN, AlP, AlAs, AlSb, InN, InP, InAs, InSb, GaNP, GaNAs, GaNSb, GaPAs, GaPSb, AlNP, AlNAs, AlNSb, AlPAs, AlPSb, InNP, InNAs, InNSb, InPAs, InPSb, GaAlNP, GaAlNAs, GaAlNSb, GaAlPAs, GaAlPSb, GaInNP, GaInNAs, GaInNSb, GaInPAs, GaInPSb, InAlNP, InAlNAs, InAlNSb, InAlPAs and InAlPSb.

Specific examples of the IV-VI compounds include SnS, SnSe, SnTe, PbS, PbSe, PbTe, SnSeS, SnSeTe, SnSTe, PbSeS, PbSeTe, PbSTe, SnPbS, SnPbSe, SnPbTe, SnPbSSe, SnPbSeTe and SnPbSTe.

Specific examples of the IV compounds include Si, Ge, SiC and SiGe.

The quantum dot phosphor may have a core-shell structure. It is possible to improve the quantum efficiency of the quantum dot phosphor by selecting a compound having a wider band gap for the shell than the band gap of a compound used for the core. Examples of the combination of the core and the shell (core/shell) include CdSe/ZnS, InP/ZnS, PbSe/PbS, CdSe/CdS, CdTe/CdS and CdTe/ZnS.

The quantum dot phosphor may have a core-multi-shell structure, in which the shell is multi-layered. It is possible to further improve the quantum efficiency of the quantum dot phosphor by disposing one or more shells having a narrower band gap on the core having a wider band gap, and further disposing a shell having a wider band gap.

The wavelength conversion layer may include a single kind of phosphor or two or more kinds of phosphors in combination. When the wavelength conversion layer includes two or more kinds of phosphors, the combination thereof may have different components and the same average particle size, different average particle sizes and the same component, or different average particle sizes and different components, for example. By changing at least one of the component or the average particle size of the phosphor, the light-emission central wavelength of the phosphor can be changed.

When the wavelength conversion layer includes a quantum dot phosphor, the content of the quantum dot phosphor is preferably 50% by mass or more, more preferably 70% by mass or more, further preferably 80% by mass or more, with respect to the total amount of the phosphor.

For example, the wavelength conversion layer may include a phosphor G, having a light-emission central wavelength in a green wavelength region of from 520 nm to 560 nm, and a phosphor R, having a light-emission central wavelength in a red wavelength region of from 600 nm to 680 nm.

When the wavelength conversion layer including a phosphor G and a phosphor R is exposed to exciting light having a light-emission central wavelength in a blue wavelength region of from 430 nm to 480 nm, the phosphor G and the phosphor R emit green light and red light, respectively. As a result, white light is obtained from the green light and the red light emitted from the phosphor G and the phosphor R, and the blue light transmitting the cured product.

The content of the phosphor in the wavelength conversion layer is, for example, preferably from 0.01% by mass to 1.0% by mass, more preferably from 0.05% by mass to 0.5% by mass, further preferably from 0.1% by mass to 0.5% by mass, with respect to the total wavelength conversion layer. When the content of the phosphor is 0.01% by mass or more with respect to the total wavelength conversion layer, a sufficient degree of wavelength conversion function tends to be achieved. When the content of the phosphor is 1.0% by mass or less with respect to the total wavelength conversion layer, aggregation of a phosphor tends to be suppressed.

(Light Scattering Material)

The type of the light scattering material included in the wave conversion layer is not specifically limited, and examples thereof include titanium oxide, barium sulfate, zinc oxide, and calcium carbonate. Among these, titanium oxide is preferred from the viewpoint of light scattering efficiency. The titanium oxide may be rutile type or anatase type, preferably rutile type.

When the light scattering material includes titanium oxide, the content of titanium oxide with respect to the total light scattering material is preferably 50% by mass or more, more preferably 70% by mass or more, further preferably 80% by mass or more.

The content of the light scattering material in the wavelength conversion layer is not particularly limited, and may be selected depending on the desired wavelength conversion efficiency, light transmittance or the like. For example, the content of the light scattering material with respect to the total wavelength conversion layer is preferably from 0.1% by mass to 10.0% by mass, more preferably from 1.0% by mass to 7.5% by mass, further preferably from 2.0% by mass to 5.0% by mass.

The average particle size of the light scattering material is preferably from 0.1 μm to 1 μm, more preferably from 0.2 μm to 0.8 μm, further preferably from 0.2 μm to 0.5 μm.

In the present disclosure, the average particle size of the light scattering material may be measured by the following method.

The light scattering material (when included in the wavelength conversion layer or a resin composition as described layer, the light scattering material is extracted therefrom) is dispersed in a purified water including a surfactant to prepare a dispersion. Then, a volume-based particle size distribution of the dispersion is measured with a laser diffraction particle size analyzer (for example, SALD-3000J, Shimadzu Corporation) and the particle size at which the accumulation from the side of smaller particle size is 50% (median diameter (D50)) is determined as the average particle size of the light scattering material.

The extraction of the light scattering material from a resin composition can be performed by, for example, diluting the resin composition with a liquid medium and allowing the light scattering material to precipitate, and collecting the same by performing centrifugal separation or the like.

When the light scattering material is included in the wavelength conversion layer, an arithmetic average value of equivalent circle diameters (average value of major axis and minor axis) of 50 particles at a section of the wavelength conversion layer, observed with a scanning electron microscope, may be regarded as the average particle size of the light scattering material.

From the viewpoint of improving the dispersibility of the light scattering material in the wavelength conversion layer, the light scattering material preferably has an organic substance layer that includes an organic substance, at least at a portion of the surface of the light scattering material.

Specific examples of the organic substance included in the organic substance layer include organic silanes, organosiloxanes, fluorosilanes, organic phosphonates, organic phosphoric acid compounds, organic phosphinates, organic sulfonic acid compounds, carboxylic acids, carboxylic acid esters, carboxylic acid derivatives, amides, hydrocarbon waxes, polyolefins, polyolefin copolymers, polyols, polyol derivatives, alkanolamines, alkanolamine derivatives, and organic dispersants.

The organic substance included in the organic substance layer preferably includes a polyol or an organic silane, more preferably at least one of a polyol or an organic silane.

Specific examples of the organic silane include octyltriethoxysilane, nonyltriethoxysilane, decyltriethoxysilane, dodecyltriethoxysilane, tridecyltriethoxysilane, tetradecyltriethoxysilane, pentadecyltriethoxysilane, hexadecyltriethoxysilane, heptadecyltriethoxysilane, and octadecyltriethoxysilane.

Specific examples of the organosiloxane include polydimethylsiloxane (PDMS) terminated with a trimethylsilyl group, polymethylhydrosiloxane (PMHS), and a polysiloxane derived by functionalization of PMHS with an olefin (hydrosilylation).

Specific examples of the organic phosphonate include n-octyl phosphonic acid and an ester thereof, n-decyl phosphonic acid and an ester thereof, 2-ethylhexyl phosphonic acid and an ester thereof, and camphyl phosphonic acid and an ester thereof.

Specific examples of the organic phosphoric acid compound include organic acidic phosphate, organic pyrophosphate, organic polyphosphate, organic metaphosphate, and a salt thereof.

Specific examples of the organic phosphinate include n-hexyl phosphinic acid and an ester thereof, n-octyl phosphinic acid and an ester thereof, di-n-hexyl phosphinic acid and an ester thereof, and di-n-octyl phosphinic acid and an ester thereof.

Specific examples of the organic sulfonic acid include alkyl sulfonic acids, such as hexyl sulfonic acid, octyl sulfonic acid and 2-ethylhexyl sulfonic acid, and a salt of these alkyl sulfonic acids with a metal ion such as sodium, calcium, magnesium, aluminum or titanium, an ammonium ion, or an organic ammonium ion such triethanolamine.

Specific examples of the carboxylic acid include maleic acid, malonic acid, fumaric acid, benzoic acid, phthalic acid, stearic acid, oleic acid and linoleic acid.

Specific examples of the carboxylic acid ester include an ester or a partial ester obtained by reaction of these carboxylic acids with a hydroxy compound such as ethylene glycol, propylene glycol, trimethylol propane, diethanolamine, triethanolamine, glycerol, hexanetriol, erythritol, mannitol, sorbitol, pentaerythritol, bisphenol A, hydroquinone or phloroglucinol.

Specific examples of the amide include stearic acid amide, oleic acid amide erucic acid amide.

Specific examples of the polyolefin and polyolefin copolymer include polyethylene, polypropylene, and a copolymer of ethylene with at least one compound selected from propylene, butylene, vinyl acetate, acrylate and acrylamide.

Specific examples of the polyol include glycerol, trimethylol ethane, and trimethylol propane.

Specific examples of the alkanolamine include diethanolamine and triethanolamine.

Specific examples of the organic dispersant include citric acid, polyacrylic acid, polymethacrylic acid, and polymeric organic dispersants having a functional group such as an anionic group, a cationic group, an ampholytic group or a nonionic group.

From the viewpoint of improving the dispersibility in the wavelength conversion layer, the light scattering material may have a metal oxide layer that includes a metal oxide, at least at a portion of the surface of the light scattering material. Examples of the metal oxide included in the metal oxide layer include silica, alumina, zirconia, phosphoria and boria. The light scattering material may have a single metal oxide layer alone, or may have two or more metal oxide layers.

When the light scattering material has two metal oxide layers, the layers preferably include a first metal oxide layer that includes silica and a second metal oxide layer that includes alumina.

When the light scattering material has an organic substance layer that includes an organic substance and a metal oxide layer, it is preferred to provide the metal oxide layer and the organic substance layer, on the surface of the light scattering material, in this order.

When the light scattering material has an organic substance layer and two metal oxide layers, it is preferred to provide the first metal oxide layer including silica, the second metal oxide layer including alumina, and the organic substance layer, on the surface of the light scattering material, in this order (i.e., the organic substance layer is the outermost layer).

(Resin Cured Product)

The wavelength conversion layer may include a resin cured product.

From the viewpoint of improving the adhesion with respect to another member (such as a covering material) and suppressing the formation of wrinkles caused by volume constriction upon curing, the resin cured product preferably includes a sulfide structure. The resin cured product including the sulfide structure may be obtained by, for example, curing a resin composition that includes a thiol compound and a polymerizable compound having a carbon-carbon double bond that causes ene-thiol reaction with a thiol group of the thiol compound.

From the viewpoint of resistance to heat and resistance to heat and moist, the resin cured product preferably includes an alicyclic structure or an aromatic ring structure. The resin cured product including an alicyclic structure or an aromatic ring structure may be obtained by, for example, curing a resin composition including a compound having an alicyclic structure or an aromatic ring structure as the polymerizable compound to be described later.

From the viewpoint of suppressing the contact of a phosphor with oxygen, the resin cured product preferably includes an alkyleneoxy group. When the resin cured product includes an alkyleneoxy group, polarity of the resin cured product tends to be increased and oxygen, which is non-polarized, tends to be less soluble in the component of the resin cured product. Further, the resin cured product tends to be more flexible and the adhesion with respect to a covering material tends to be improved.

The resin cured product including an alkyleneoxy group may be obtained by, for example, curing a resin composition including a compound having an alkyleneoxy group as the polymerizable compound to be described later.

The wavelength conversion layer may be a cured product of a composition including a phosphor, a light scattering material, a polymerizable compound and a photopolymerization initiator (hereinafter, also referred to as a resin composition).

The resin composition preferably includes a phosphor, a thiol compound, at least one selected from a group consisting of a (meth)acrylic compound and a (meth)allyl compound, and a photopolymerization initiator. The resin composition may include other components, as necessary.

In the following, components included in the resin composition are described.

(Phosphor)

The details of the phosphor included in the resin composition are as described above. The phosphor may be used as a phosphor dispersion in which the phosphor is dispersed in a dispersing medium. Examples of the dispersing medium include an organic solvent, a silicone compound and a monofunctional (meth)acrylate compound. The phosphor may be used as a phosphor dispersion using a dispersant.

The organic solvent that may be used as a dispersing medium is not particularly limited, as long as precipitation or aggregation of the phosphor is not confirmed, and examples thereof include acetonitrile, methanol, ethanol, acetone, 1-propanol, ethyl acetate, butyl acetate, toluene and hexane.

Examples of the silicone compound that may be used as the dispersing medium include straight silicone oils such as dimethyl silicone oil, methyl phenyl silicone oil and methyl hydrogen silicone oil; modified silicone oils such as amino-modified silicone oil, epoxy-modified silicone oil, carboxy-modified silicone oil, carbinol-modified silicone oil, mercapto-modified silicone oil, silicone oil modified with different functional groups, polyether-modified silicone oil, methyl styryl-modified silicone oil, hydrophilic specially-modified silicone oil, higher alkoxy-modified silicone oil, higher aliphatic acid-modified silicone oil and fluorine-modified silicone oil.

The monofunctional (meth)acrylate compound that may be used as the dispersing medium is not particularly limited, as long as it is in a liquid form at room temperature (25° C.), and examples thereof include a monofunctional (meth)acrylate compound having an alicyclic structure (preferably isobornyl (meth)acrylate and dicyclopentanyl (meth)acrylate), methoxy polyethylene glycol (meth)acrylate, phenoxy polyethylene glycol (meth)acrylate, and ethoxylated o-phenyl phenol (meth)acrylate.

The dispersion may include a dispersant, as necessary. Examples of the dispersant include polyetheramine (JEFFAMINE M-1000, Huntsman Corporation).

The content of the phosphor in the phosphor dispersant is preferably from 1% by mass to 20% by mass, more preferably from 1% by mass to 10% by mass.

When the content of the phosphor in the phosphor dispersion is from 1% by mass to 20% by mass, the content of the phosphor dispersion in the total resin composition is preferably from 1% by mass to 10% by mass, more preferably from 4% by mass to 10% by mass, further preferably from 4% by mass to 7% by mass, for example.

The content of the phosphor in the total amount of the resin composition is preferably from 0.01% by mass to 1.0% by mass, more preferably from 0.05% by mass to 0.5% by mass, further preferably from 0.1% by mass to 0.5% by mass, for example.

When the content of the phosphor is 0.01% by mass or more, a sufficient degree of emission intensity upon exposure to exciting light tends to be achieved. When the content of the phosphor is 1.0% by mass or less, aggregation of the phosphor tends to be suppressed.

(Polymerizable Compound)

The resin composition includes a polymerizable compound. The polymerizable compound included in the resin composition is not particularly limited, and examples thereof include a thiol compound, a (meth)acrylic compound and a (meth)allyl compound.

The (meth)allyl compound refers to a compound having a (meth)allyl group in the molecule, and the (meth)acrylic compound refers to a compound having a (meth)acryloyl group in the molecule. For the purpose of convenience, a compound having both a (meth)allyl group and a (meth)acryloyl group is regarded as a (meth)allyl compound.

From the viewpoint of the adhesion between the wavelength conversion layer and an adjacent member (such as a covering material), the resin composition preferably includes, as the polymerizable compound, a thiol compound and at least one selected from the group consisting of a (meth)acrylic compound and a (meth)allyl compound.

The cured product, which is obtained by curing a resin composition that includes a thiol compound and at least one selected from the group consisting of a (meth)acrylic compound and a (meth)allyl compound, includes a sulfide structure (R—S—R′, wherein R and R′ are an organic group) that is formed by ene-thiol reaction caused by a thiol group and a carbon-carbon double bond in a (meth)acryloyl group or a (meth)allyl group. As a result, adhesion between the wavelength conversion layer and an adjacent member tends to improve. Further, optical properties of the wavelength conversion layer tend to improve.

In the following, a thiol compound, a (meth)acrylic compound and a (meth)allyl compound are described.

A. Thiol Compound

The thiol compound may be a monofunctional thiol compound, having one thiol group in one molecule, or a polyfunctional thiol compound, having two or more thiol groups in one molecule. The resin composition may include a single kind of thiol compound, or may include two or more kinds in combination.

The thiol compound may have a polymerizable group other than a thiol group (such as a (meth)acryloyl group or a (meth)allyl group) in the molecule, or may not have a polymerizable group other than a thiol group.

In the present disclosure, a compound having a thiol group and a polymerizable group other than a thiol group in the molecule is regarded as a thiol compound.

Specific examples of the monofunctional thiol compound include hexanethiol, 1-heptanethiol, 1-octanethiol, 1-nonanethiol, 1-decanethiol, 3-mercaptopropionic acid, methyl mercaptopropionate, methoxybutyl mercaptopropionate, octyl mercaptopropionate, tridecyl mercaptopropionate, 2-ethylhexyl-3-mercaptopropionate, and n-octyl-3-mercaptopropionate.

Specific examples of the polyfunctional thiol compound include ethylene glycol bis(3-mercaptopropionate), diethylene glycol bis(3-mercaptopropionate), tetraethylene glycol bis(3-mercaptopropionate), 1,2-propylene glycol bis(3-mercaptopropionate), diethylene glycol bis(3-mercaptobutylate), 1,4-butanediol bis(3-mercaptopropionate), 1,4-butandiol bis(3-mercaptobutylate), 1,8-octanediol bis(3-mercaptopropionate), 1,8-octanediol bis(3-mercaptobutylate), hexanediol bisthioglycolate, trimethylolpropane tris(3-mercaptopropionate), trimethylolpropane tris(3-mercaptobutylate), trimethylolpropane tris(3-mercaptoisobutylate), trimethylolpropane tris(2-mercaptoisobutylate), trimethylolpropane tristhioglycolate, tris-[(3-mercaptopropionyloxy)-ethyl]-isocyanurate, trimethylolethane tris(3-mercaptobutylate), pentaerythritol tetrakis(3-mercaptopropionate), pentaerythritol tetrakis(3-mercaptobutylate), pentaerythritol tetrakis(3-mercaptoisobutylate), pentaerythritol tetrakis(2-mercaptoisobutylate), dipentaerythritol hexakis(3-mercaptopropionate), dipentaerythritol hexakis(2-mercaptopropionate), dipentaerythritol hexakis(3-mercaptobutylate), dipentadrythritol hexakis(3-mercaptoisobutylate), dipentaerythritol hexakis (2-mercaptoisobutylate), pentaerythritol tetrakis thioglycolate, and dipentaerythritol hexakis thioglycolate.

From the viewpoint of improving the adhesion between the wavelength conversion layer and an adjacent member, resistance to heat, and resistance to heat and moist, the thiol compound preferably includes a polyfunctional thiol compound. The content of the polyfunctional thiol compound with respect to the total amount of the thiol compound is preferably 80% by mass or more, more preferably 90% by mass or more, further preferably 100% by mass, for example.

The thiol compound may be in a state of a thioether oligomer, which is obtained by reaction of a thiol compound with a (meth)acrylic compound. It is possible to obtain a thioether oligomer by causing addition polymerization of a thiol compound with a (meth)acrylic compound under the presence of a polymerization initiator.

When the resin composition includes a thiol compound, the content of the thiol compound is preferably from 5% by mass to 80% by mass, more preferably 15% by mass to 70% by mass, further preferably from 20% by mass to 60% by mass, for example, with respect to the total amount of the resin composition.

When the content of the thiol compound is 5% by mass or more, adhesion of a cured product with respect to an adjacent member tends to further improve. When the content of the thiol compound is 80% by mass or less, resistance to heat and resistance to heat and moisture tend to further improve.

B. (Meth)Acrylic Compound

The (meth)acrylic compound may be a monofunctional (meth)acrylic compound having one (meth)acryloyl group in one molecule, or may be a polyfunctional (meth)acrylic compound having two or more (meth)acryloyl groups in one molecule. The resin composition may include a single kind of (meth)acrylic compound, or may include two or more kinds in combination.

Specific examples of the monofunctional (meth)acrylic compound include (meth)acrylic acid; alkyl (meth)acrylates having an alkyl group of 1 to 18 carbon atoms, such as methyl (meth)acrylate, n-butyl (meth)acrylate, isobutyl (meth)acrylate, 2-ethylhexyl (meth)acrylate, isononyl (meth)acrylate, n-octyl (meth)acrylate, lauryl (meth)acrylate, and stearyl (meth)acrylate;

(meth)acrylate compounds having an aromatic ring, such as benzyl (meth)acrylate and phenoxyethyl (meth)acrylate; alkoxyalkyl (meth)acrylate, such as butoxyethyl (meth)acrylate; aminoalkyl (meth)acrylates, such as N,N-dimethylaminoethyl (meth)acrylate; polyalkylene glycol monoalkyl ether (meth)acrylate, such as diethylene glycol monoethyl ether (meth)acrylate, triethylene glycol monobutyl ether (meth)acrylate, tetraethylene glycol monomethyl ether (meth)acrylate, hexaethylene glycol monomethyl ether (meth)acrylate, octaethylene glycol monomethyl ether (meth)acrylate, nonaethylene glycol monomethyl ether (meth)acrylate, dipropylene glycol monomethyl ether (meth)acrylate, heptapropylene glycol monomethyl ether (meth)acrylate, and tetraethylene glycol monoethyl ether (meth)acrylate; polyalkylene glycol monoaryl ether (meth)acrylates, such as hexaethylene glycol monophenyl ether (meth)acrylate; (meth)acrylate compounds having an alicyclic structure, such as cyclohexyl (meth)acrylate, dicyclopentanyl (meth)acrylate, isobornyl (meth)acrylate, and methylene oxide-added cyclododecatriene (meth)acrylate; (meth)acrylate compounds having a hetero ring, such as (meth)acryloyl morpholine and tetrahydrofurfuryl (meth)acrylate; fluoroalkyl (meth)acrylates, such as heptadecafluorodecyl (meth)acrylate; (meth)acrylate compounds having a hydroxy group, such as 2-hydroxyethyl (meth)acrylate, 3-hydroxypropyl (meth)acrylate, 4-hydroxybutyl (meth)acrylate, triethylene glycol mono(meth)acrylate, tetraethylene glycol mono(meth)acrylate, hexaethylene glycol mono(meth)acrylate, and octapropylene glycol mono(meth)acrylate; (meth)acrylate compounds having a glycidyl group, such as glycidyl (meth)acrylate; (meth)acrylate compounds having an isocyanate group, such as 2-(2-(meth)acryloyloxyethyloxy)ethyl isocyanate, and 2-(meth)acryloyloxyethyl isocyanate; polyalkylene glycol mono(meth)acrylates, such as tetraethylene glycol mono(meth)acrylate, hexaethylene glycol mono(meth)acrylate, and octapropylene glycol mono(meth)acrylate; (meth)acrylamide compounds, such as (meth)acrylamide, N,N-dimethyl (meth)acrylamide, N-isopropyl (meth)acrylamide, N,N-dimethylaminopropyl (meth)acrylamide, N,N-diethyl (meth)acrylamide, and 2-hydroxyethyl (meth)acrylamide.

Specific examples of the polyfunctional (meth)acrylic compound include alkylene glycol di(meth)acrylates, such as 1,4-butanediol di(meth)acrylate, 1,6-hexanediol di(meth)acrylate, and 1,9-nonanediol di(meth)acrylate; polyalkylene glycol di(meth)acrylates, such as polyethylene glycol di(meth)acrylate, and polypropylene glycol di(meth)acrylate; tri(meth)acrylate compounds, such as trimethylol propane tri(meth)acrylate, ethylene oxide-added trimethylol propane tri(meth)acrylate, and tris(2-acryloyloxyethyl) isocyanurate; tetra(meth)acrylate compounds, such as ethylene oxide-added pentaerythritol tetra(meth)acrylate, trimethylol propane tetra(meth)acrylate, and pentaerythritol tetra(meth)acrylate; and (meth)acrylate compounds having an alicyclic structure, such as tricyclodecane dimethanol di(meth)acrylate, cyclohexane dimethanol di(meth)acrylate, 1,3-adamantane dimethanol di(meth)acrylate, hydrogenated bisphenol A (poly)ethoxy di(meth)acrylate, hydrogenated bisphenol A (poly)propoxy di(meth)acrylate, hydrogenated bisphenol F (poly)ethoxy di(meth)acrylate, hydrogenated bisphenol F (poly)propoxy di(meth)acrylate, hydrogenated bisphenol S (poly)ethoxy di(meth)acrylate, and hydrogenated bisphenol S (poly)propoxy di(meth)acrylate.

From the viewpoint of further improving the resistance to heat and resistance to heat and moisture of a cured product, the (meth)acrylic compound is preferably a (meth)acrylate compound having an alicyclic structure or an aromatic ring structure. Examples of the alicyclic structure or the aromatic ring structure include an isobornyl structure, a tricyclodecane structure and a bisphenol structure.

The (meth)acrylic compound may be a (meth)acrylic compound having an alkyleneoxy group, or may be a difunctional (meth)acrylic compound having an alkyleneoxy group.

The alkyleneoxy group is preferably an alkyleneoxy group having 2 to 4 carbon atoms, more preferably an alkyleneoxy group having 2 or 3 carbon atoms, and an alkyleneoxy group having 2 carbon atoms.

The (meth)acrylic compound may have a single kind of alkyleneoxy group, or may have two or more kinds thereof.

The compound having an alkyleneoxy group may be a compound having a polyalkyleneoxy group, which includes multiple alkyleneoxy groups.

When the (meth)acrylic compound has an alkyleneoxy group, the number of the alkyleneoxy group in one molecule is preferably from 2 to 30, more preferably from 2 to 20, further preferably from 3 to 10, particularly preferably from 3 to 5.

When the (meth)acrylic compound has an alkyleneoxy group, the compound preferably has a bisphenol structure in view of achieving favorable heat resistance. Examples of the bisphenol structure include a bisphenol A structure and a bisphenol F structure, preferably a bisphenol A structure.

Specific examples of the (meth)acrylic compound having an alkyleneoxy group include alkoxyalkyl (meth)acrylates, such as butoxyethyl (meth)acrylate; polyalkylene glycol monoalkyl ether (meth)acrylate, such as diethylene glycol monoethyl ether (meth)acrylate, triethylene glycol monobutyl ether (meth)acrylate, tetraethylene glycol monomethyl ether (meth)acrylate, hexaethylene glycol monomethyl ether (meth)acrylate, octaethylene glycol monomethyl ether (meth)acrylate, nonaethylene glycol monomethyl ether (meth)acrylate, dipropylene glycol monomethyl ether (meth)acrylate, heptapropylene glycol monomethyl ether (meth)acrylate, and tetraethylene glycol monoethyl ether (meth)acrylate; polyalkylene glycol monoaryl ether (meth)acrylates, such as hexaethylene glycol monophenyl ether (meth)acrylate; (meth)acrylate compounds having a hetero ring, such as tetrahydrofurfuryl (meth)acrylate; (meth)acrylate compounds having a hydroxy group, such as triethyelne glycol mono(meth)acrylate, tetraethylene glycol mono(meth)acrylate, hexaethyelene glycol mono(meth)acrylate, and octapropylene glycol mono(meth)acrylate; (meth)acrylate compounds having a glycidyl group, such as glycidyl (meth)acrylate; polyalkylene glycol di(meth)acrylates, such as polyethylene glycol di(meth)acrylate and polypropylene glycol di(meth)acrylate; tri(meth)acrylate compounds, such as ethylene oxide-added trimethylol propane tri(meth)acrylate; tetra(meth)acrylate compounds, such as ethylene oxide-added pentaerythritol tetra(meth)acrylate; and a bisphenol-type di(meth)acrylate compounds, such as ethoxylated bisphenol A di(meth)acrylate, propoxylated bisphenol A di(meth)acrylate, and propoxylated ethoxylated bisphenol A (meth)acrylate.

Among the (meth)acrylic compounds having an alkyleneoxy group, ethoxylated bisphenol A di(meth)acrylate, propoxylated bisphenol A di(meth)acrylate, and propoxylated ethoxylated bisphenol A (meth)acrylate are preferred, and ethoxylated bisphenol A di(meth)acrylate is more preferred.

When the resin composition includes a (meth)acrylic compound, the content of the (meth)acrylic compound in the resin composition may be from 40% by mass to 90% by mass or from 50% by mass to 80% by mass, with respect to the total amount of the resin composition, for example.

C. (Meth)Allyl Compound

The (meth)allyl compound may be a monofunctional (meth)allyl compound, having one (meth)allyl group in one molecule, or may be a polyfunctional (meth)allyl compound, having two or more (meth)allyl groups in one molecule. The resin composition may include a single kind of (meth)allyl compound, or may include two or more kinds in combination.

The (meth)allyl compound may have a polymerizable group other than a (meth)allyl group (such as a (meth)acryloyl group) or may not have a polymerizable group other than a (meth)allyl group.

In the present disclosure, a compound having a (meth)allyl group and a polymerizable group other than a (meth)allyl group (except for a thiol compound) is regarded as a (meth)allyl compound.

Specific examples of the monofunctional (meth)allyl compound include (meth)allyl acetate, (meth)allyl n-propionate, (meth)allyl benzoate, (meth)allyl phenyl acetate, (meth)allyl phenoxy acetate, (meth)allyl methyl ether, and (meth)allyl glycidyl ether.

Specific examples of the polyfunctional (meth)allyl compound include di(meth)allyl benzenedicarboxylate, di(meth)allyl cyclohexanedicarboxylate, di(meth)allyl maleate, di(meth)allyl adipate, di(meth)allyl phthalate, di(meth)allyl isophthalate, di(meth)allyl terephthalate, glycerin di(meth)allyl ether, trimethylolpropane di(meth)allyl ether, pentaerythritol di(meth)allyl ether, 1,3-di(meth)allyl-5-glycidyl isocyanurate, tri(meth)allyl cyanurate, tri(meth)allyl isocyanurate, tri(meth)allyl trimellitate, tetra(meth)allyl pyromellitate, 1,3,4,6-tetra (meth)allyl glycoluril, 1,3,4,6-tetra (meth)allyl-3a-methyl glycoluril, and 1,3,4,6-tetra (meth)allyl-3a,6a-dimethyl glycoluril.

From the viewpoint of the resistance to heat and the resistance to heat and moist of a cured product, the (meth)allyl compound is preferably at least one selected from the group consisting of a compound having an isocyanurate structure such as tri(meth)allyl isocyanurate, tri(meth)allyl cyanurate, di(meth)allyl benzenedicarboxylate, and di(meth)allyl cyclohexanedicarboxylate; more preferably a compound having a triisocyanurate structure; further preferably tri(meth)allyl isocyanurate.

When the resin composition includes a (meth)allyl compound, the content of the (meth)allyl compound in the resin composition may be from 10% by mass to 50% by mass or from 15% by mass to 45% by mass, with respect to the total amount of the resin composition, for example.

In an embodiment, the polymerizable compound may include a thioether oligomer as a thiol compound and a (meth)allyl compound (preferably a polyfunctional (meth)allyl compound).

When the polymerizable compound includes a thioether oligomer as a thiol compound and a (meth)allyl compound, and includes a phosphor as a phosphor, the phosphor is preferably in a state of a dispersion in which the phosphor is dispersed in a silicone compound as a dispersing medium.

In an embodiment, the polymerizable compound may include a thiol compound that is not in a state of a thioether oligomer and a (meth)acrylic compound (preferably a polyfunctional (meth)acrylic compound, more preferably a difunctional (meth)acrylic compound).

When the polymerizable compound includes a thiol compound that is not in a state of thioether oligomer and a (meth)acrylic compound, and includes a quantum dot phosphor as a phosphor, the quantum dot phosphor is preferably in a state of a dispersion in which the quantum dot phosphor is dispersed in a (meth)acrylic compound, preferably a monofunctional (meth)acrylic compound, more preferably isobornyl (meth)acrylate, as a dispersing medium.

(Photopolymerization Initiator)

The photopolymerization initiator included in the resin composition is not particularly limited, and examples thereof include a compound that generates radicals when it is exposed to active energy rays such as ultraviolet rays.

Specific examples of the photopolymerization initiator include aromatic ketone compounds, such as benzophenone, N,N′-tetraalkyl-4,4-di aminobenzophenone, 2-benzyl-2-dimethylamino-1-(4-morpholinophenyl)-butanone-1, 2-methyl-1-[4-(methylthio)phenyl]-2-morpholino-propanone-1, 4,4′-bis(dimethylamino)benzophenone (Michler's ketone), 4,4′-bis(diethylamino)benzophenone, 4-methoxy-4′-dimethylaminobenzophenone, 1-hydroxy cyclohexyl phenyl ketone, 1-(4-isopropylphenyl)-2-hydroxy-2-methylpropan-1-one, 1-(4-(2-hydroxyethoxy)-phenyl)-2-hydroxy-2-methyl-1-propan-1-one, and 2-hydroxy-2-methyl-1-phenylpropan-1-one; quinone compounds, such as alkyl anthraquinone and phenanthrenequinone; benzoin compounds, such as benzoin and alkylbenzoin; benzoin ether compounds, such as benzoin alkyl ether and benzoin phenyl ether; benzil derivatives, such as benzil dimethylketal; 2,4,5-triaryl imidazole dimers, such as 2-(o-chlorophenyl)-4,5-diphenyl imidazole dimer, 2-(o-chlorophenyl)-4,5-di(m-methoxyphenyl) imidazole dimer, 2-(o-fluorophenyl)-4,5-diphenyl imidazole dimer, 2-(o-methoxyphenyl)-4,5-diphenyl imidazole dimer, 2,4-di(p-methoxyphenyl)-5-phenyl imidazole dimer, and 2-(2,4-dimethoxyphenyl)-4,5-diphenyl imidazole dimer; acridine derivatives, such as 9-phenyl acridine, and 1,7-(9,9′-acridinyl)heptane; oxime ester compounds, such as 1,2-octanedione 1-[4-(phenylthio)-2-(O-benzoyloxime)], and ethanone 1-[9-ethyl-6-(2-methylbenzoyl)-9H-carbazol-3-yl]-1-(O-acetyloxime); coumarin compounds, such as 7-diethylamino-4-methyl coumarin; thioxanthone compounds, such as 2,4-diethyl thioxanthone; and acylphosphine oxide compounds, such as 2,4,6-trimethylbenzoyl-diphenyl-phosphine oxide and 2,4,6-trimethylbenzoyl-phenyl-ethoxy-phosphine oxide.

The resin composition may include a single kind of photopolymerization initiator, or may include two or more kinds in combination.

From the viewpoint of curability, the photopolymerization initiator is preferably at least one selected from the group consisting of an acylphosphine oxide compound, an aromatic ketone compound and an oxime ester compound, more preferably at least one selected from the group consisting of an acylphosphine oxide compound and an aromatic ketone compound, further preferably an acylphosphine oxide compound.

The content of the photopolymerization initiator with respect to the total amount of the resin composition is preferably from 0.1% by mass to 5% by mass, more preferably from 0.1% by mass to 3% by mass, further preferably from 0.1% by mass to 1.5% by mass, for example. When the content of the photopolymerization initiator is 0.1% by mass or more, the resin composition tends to have a sufficient degree of sensitivity. When the content of the photopolymerization initiator is 5% by mass or less, effects on color hue or deterioration in storage stability of the resin composition tends to be suppressed.

(Light Scattering Material)

The details of the light scattering material included in the resin composition are as described above.

(Other Components)

The resin composition may include a component other than the components as described above. For example, the resin composition may include a solvent, a dispersant, a polymerization inhibitor, a silane coupling agent, a surfactant, an adhesion-imparting agent, an antioxidant, and the like. Each of these components may be used alone or in combination of two or more kinds thereof.

(Method for Preparing Resin Composition)

The resin composition may be prepared by mixing a phosphor, a polymerizable compound, a photopolymerization initiator, and other components as necessary, by an ordinary method.

The wavelength conversion layer may be obtained by curing a single kind of resin composition or two or more kinds thereof. For example, when the wavelength conversion layer is in a state of a film, the wavelength conversion layer may have a configuration in which a first cured product layer and a second cured product layer are layered, wherein the first cured product layer is obtained by curing a resin composition including a first phosphor and the second cured product layer is obtained by curing a resin composition including a second phosphor.

From the viewpoint of further improving the adhesion, the wavelength conversion layer preferably has a loss tangent (tan 6), as measured by dynamic viscoelastic measurement at a frequency of 10 Hz and 25° C., of from 0.4 to 1.5, more preferably from 0.4 to 1.2, further preferably from 0.4 to 0.6. The loss tangent (tan 6) of the wavelength conversion layer may be measured with a dynamic viscoelasticity measurement device (for example, Solid Analyzer RSA-III, Rheometric Scientific Ltd.)

From the viewpoint of further improving the adhesion, resistance to heat, and resistance to heat and moist, the wavelength conversion layer preferably has a glass transition temperature (Tg) of preferably from 85° C. or more, more preferably from 85° C. to 160° C., further preferably from 90° C. to 120° C. The glass transition temperature (Tg) of the wavelength conversion layer may be measured with a dynamic viscoelasticity measurement device (for example, Solid Analyzer RSA-III, Rheometric Scientific Ltd.) at a frequency of 10 Hz.

From the viewpoint of further improving the adhesion with respect to the covering materials, resistance to heat, and resistance to heat and moist, the wavelength conversion layer preferably has a storage elastic modulus, as measured at a frequency of 10 Hz and 25° C., of from 1×10⁷ Pa to 1×10¹⁰ Pa, more preferably from 5×10⁷ Pa to 1×10¹⁰ Pa, further preferably from 5×10⁷ Pa to 5×10⁹ Pa. The storage elastic modulus of the wavelength conversion layer may be measured with a dynamic viscoelasticity measurement device (for example, Solid Analyzer RSA-III, Rheometric Scientific Ltd.)

The wavelength conversion layer may be obtained by, for example, forming a coating film or an article of the resin composition, drying the same as necessary, and irradiating the same with active energy rays such as ultraviolet rays.

The wavelength and the irradiance of the active energy rays can be adjusted depending on the components of the resin composition. In an embodiment, ultraviolet rays in a wavelength region of from 280 nm to 400 nm is used at an irradiance of from 100 mJ/cm² to 5,000 mJ/cm²·Examples of the light source for ultraviolet rays include a low-pressure mercury lamp, a middle-pressure mercury lamp, a high-pressure mercury lamp, a super-high-pressure mercury lamp, a carbon arc lamp, a metal halide lamp, a xenon lamp, a chemical lamp, a black light lamp, and a microwave-excited mercury lamp.

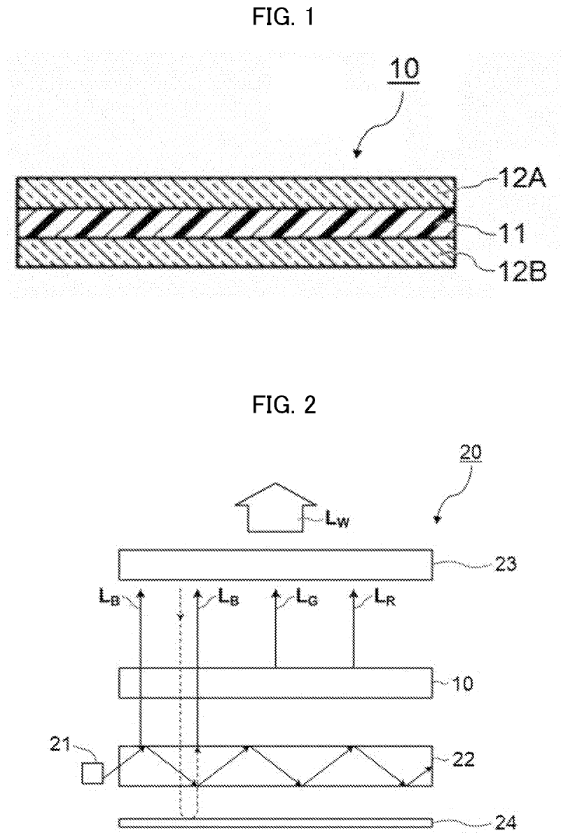

FIG. 1 shows an example of a schematic configuration of the wavelength conversion member. However, the wavelength configuration member according to the present disclosure is not limited to the configuration of FIG. 1.

In FIG. 1, wavelength conversion member 10 has wavelength conversion layer 11, and covering materials 12A and 12B disposed at respective sides of wavelength conversion layer 11. The type and the average thickness of covering materials 12A and 12B may be the same or different from each other. Covering materials 12A and 12B may have a roughened surface.

The wavelength conversion member of the configuration shown in FIG. 1 may be produced by a process as described below, for example.

First, a coating layer is formed on a film-like covering material, which is conveyed in a continuous manner (hereinafter, referred to as a first covering material), by applying a resin composition for forming a wavelength conversion layer. The method of applying the resin composition is not particularly limited, and may be performed by die coating, curtain coating, extrusion coating, rod coating, roll coating or the like.

Next, a film-like covering material, which is conveyed in a continuous manner (hereinafter, referred to as a second covering material), is disposed on the coating layer.

Subsequently, either the first covering material or the second covering material, which is transmissive to active energy rays, is exposed to active energy rays, thereby curing the coating layer to form a cured product layer. Thereafter, the laminate is cut into a desired size, and a wavelength conversion member having a configuration shown in FIG. 1 is obtained.

When neither the first covering material nor the second covering material is transmissive to active energy rays, it is possible to form a cured product layer by exposing the coating layer to active energy rays before disposing the second covering material thereon.

<<Wavelength Conversion Member (Second Embodiment)>>

The wavelength conversion member according to a second embodiment is a wavelength conversion member, comprising a wavelength conversion layer that comprises a phosphor and a light scattering material, a content of the light scattering material in a total wavelength conversion layer being 2.0% by mass or more.

The wavelength conversion member satisfying the above conditions can achieve a desired color tone with suppressed amounts of phosphors. The reason for this is not clear, but is assumed to be the following.

The wavelength conversion member converts a part of the incident light (for example, blue light) to light with different wavelengths (for example, red light and green light), whereby light with a desired color tone (for example, white light) is obtained. Accordingly, in order to achieve a desired color tone without increasing the amount of a phosphor, it is effective to enhance the efficiency for wavelength conversion per unit amount of a phosphor.

In the wavelength conversion member according to the present embodiment, the wavelength conversion efficiency per unit amount of a phosphor is enhanced by including a light scattering material in the wavelength conversion layer, together with a phosphor. Further, the content of the light scattering material to be included in the wavelength conversion member is 2.0% by mass or more. This acts as a factor for a further enhancement in the wavelength conversion efficiency per unit amount of a phosphor, and for a reduction in the amount of a phosphor that is necessary to achieve a desired color tone. As a result, a desired color tone can be achieved while suppressing the amount of a phosphor.

The upper limit of the content of the light scattering material is not particularly limited. From the viewpoint of ensuring a sufficient degree of brightness, the content of the light scattering material with respect to the total wavelength conversion layer is preferably 10.0% by mass or less, more preferably 5.0% by mass or less.

As for the details and preferred embodiments of the wavelength conversion member and the components thereof, the details and preferred embodiments of the wavelength conversion member and the components as mentioned above may be referred to.

<Backlight Unit>

The backlight unit according to the present disclosure has a light source and the wavelength conversion member according to the present disclosure.

From the viewpoint of improving the color reproducibility, the backlight unit is preferably adapted to multi-wavelength light sources.

In a preferred embodiment, the backlight unit emits blue light having a light-emission central wavelength within a range of from 430 nm to 480 nm and having a light-emission intensity peak with a half width of not greater than 100 nm; green light having a light-emission central wavelength within a range of from 520 nm to 560 nm and having a light-emission intensity peak with a half width of not greater than 100 nm; and red light having a light-emission central wavelength within a range of from 600 nm to 680 nm and having a light-emission intensity peak with a half width of not greater than 100 nm. The half width of the light-emission intensity peak refers to a width of the peak measured at ½ in height of the peak.

From the viewpoint of further improving the color reproducibility, the backlight unit preferably emits blue light having a light-emission central wavelength within a range of from 440 nm to 475 nm. From the same viewpoint, the backlight unit preferably emits green light having a light-emission central wavelength within a range of from 520 nm to 545 nm. From the same viewpoint, the backlight unit preferably emits red light having a light-emission central wavelength within a range of from 610 nm to 640 nm.

From the viewpoint of further improving the color reproducibility, the half width of the light-emission intensity peak of the blue light, the green light and the red light, emitted from the wavelength conversion member, is preferably not greater than 80 nm, more preferably not greater than 50 nm, further preferably not greater than 40 nm, yet further preferably not greater than 30 nm, particularly preferably not greater than 25 nm.

As regards the light source for the backlight unit, for example, a light source that emits blue light having a light-emission central wavelength within a range of from 430 nm to 480 nm may be used. The type of the light source may be LEDs (Light Emitting Diodes) or laser beams, for example.

When a light source that emits blue light is used, the wavelength conversion member preferably includes at least a phosphor R, which emits red light, and a phosphor G, which emits green light. In that case, white light is obtained by combining the red light and the green light emitted from the wavelength conversion member, and the blue light that passes through the wavelength conversion member.

It is possible to use a light source that emits ultraviolet light having a light-emission central wavelength within a range of from 300 nm to 430 nm may be used as the light source for the backlight unit, for example. The type of the light source may be LEDs or laser beams, for example.

When a light source that emits ultraviolet light is used, the wavelength conversion member preferably includes a phosphor B, which emits blue light upon excitation with exciting light, together with a phosphor R and a phosphor G. In that case, white light is obtained by combining the red light, the green light and the blue light, which are emitted from the wavelength conversion member.

The backlight unit according to the present disclosure may be edge-lighting type or direct-lighting type. FIG. 2 shows an example of a schematic configuration of a backlight unit of edge-lighting type.

In FIG. 2, backlight unit 20 has light source 21 that emits blue light L_{B}; light guide plate 22 that guides blue light L_{B} emitted from light source 21 and emits the same; wavelength conversion member 10 that is disposed opposite to light guide plate 22; retroreflection member 23 that is disposed opposite to light guide plate 22 via wavelength conversion member 10; and reflection plate 24 that is disposed opposite to wavelength conversion member 10 via light guide plate 22.

Wavelength conversion member 10 emits red light L_{R} and green light L_{G}, by using part of blue light L_{B} as exciting light, and emits red light L_{R}, green light L_{G}, and blue light L_{B} that is not used as exciting light. Retroreflection member 23 emits white light L_{w}, which is produced from red light L_{R}, green light L_{G} and blue light L_{B}.

<<Image Display Device>>

The image display device according to the present disclosure has the backlight unit according to the present disclosure. The type of the image display device is not particularly limited, and may be a liquid crystal display device, for example.

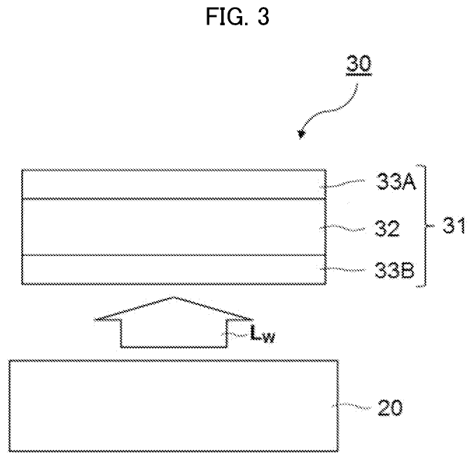

FIG. 3 shows an example of a schematic configuration of a liquid crystal display device.

In FIG. 3, liquid crystal display device 30 has backlight unit 20 and liquid crystal cell unit 31 that is disposed opposite to backlight unit 20. Liquid crystal cell unit 31 has a configuration in which liquid crystal cell 32 is disposed between polarization plate 33A and polarization plate 33B.

The drive system of liquid crystal cell 32 is not particularly limited, and examples thereof include TN (Twisted Nematic) system, STN (Super Twisted Nematic) system, VA (Vertical Alignment) system, IPS (In-Plane-Switching) system, and OCB (Optically Compensated Birefringence) system.

### EXAMPLES

In the following, the present disclosure is explained based on the Examples. However, the present disclosure is not limited to the Examples.

### Examples 1 to 4 and Comparative Examples 1 to 3

(Preparation of Resin Composition)

Resin compositions were prepared by mixing the following components in the amounts (parts by mass) indicated in Table 1.

Base resin 1: tricyclodecanedimethanol diacrylate (SR833NS, Sartomer)

Base resin 2: pentaerythrihol tetrakis(3-mercaptopropionate) (PETMP, Evans Chemetics LP)

Light scattering material: titanium oxide particles (Ti-Pure R-706, Chemours, volume average particle size: 0.36 μm)

Photopolymerization initiator: 2,4,6-trimethylbenzoyl-diphenyl-phosphine oxide (SBPI-718, Sort)

Additive: acetic acid (Kanto Chemical Co., Inc.)

Phosphor 1: quantum dot phosphor having CdSe core and ZnS shell, emits green light, peak wavelength: 526 nm, half width: 21 nm, dispersing medium: isobornyl acrylate, quantum dot phosphor concentration: 10% by mass, Nanosys Inc.)

Phosphor 2: quantum dot phosphor having InP core and ZnS shell, emits red light, peak wavelength: 625 nm, half width: 46 nm, dispersing medium: isobornyl acrylate, quantum dot phosphor concentration: 10% by mass, Nanosys Inc.)

TABLE 1

| | Examples | | | | Comparative Examples | | |
|---|---|---|---|---|---|---|---|
| Materials | 1 | 2 | 3 | 4 | 1 | 2 | 3 |
| Base resin 1 | 69.7 | 69.3 | 68.2 | 66.9 | 71.5 | 70.8 | 69.9 |
| Base resin 2 | 23.2 | 23.1 | 22.7 | 22.3 | 23.8 | 23.6 | 23.3 |
| Light scattering material | 2.00 | 2.80 | 5.00 | 7.50 | 0.35 | 1.50 | 1.50 |
| Photopolymerization | 0.5 | 0.5 | 0.5 | 0.5 | 0.5 | 0.5 | 0.5 |
| initiator | | | | | | | |
| Additive | 0.5 | 0.5 | 0.5 | 0.5 | 0.5 | 0.5 | 0.5 |
| Phosphor 1 | 2.85 | 2.64 | 2.10 | 1.59 | 2.29 | 2.13 | 3.00 |
| Phosphor 2 | 1.23 | 1.14 | 0.91 | 0.69 | 0.99 | 0.92 | 1.30 |
| Total | 100.0 | 100.0 | 100.0 | 100.0 | 100.0 | 100.0 | 100.0 |

A coating film was formed from the resin composition on one surface of a PET film having a thickness of 70 μm as a covering material. On the coating film, a PET film identical to the above was disposed. Subsequently, the resin composition was cured by irradiating with ultraviolet light using an ultraviolet ray irradiator (Eye Graphics Co., Ltd.) at an irradiance of 1,000 mJ/cm², thereby preparing a wavelength conversion member having a wavelength conversion layer and covering materials disposed at each side of the wavelength conversion layer.

The thickness of the wavelength conversion layer was adjusted such that the color tone of the light obtained by irradiating the wavelength conversion member with blue LED light of a wavelength of 449 nm satisfies a condition of white point (x, y)=(0.270, 0.240).

(Evaluation)

A sample for evaluation was prepared by cutting the wavelength conversion member to a size of 210 mm in width and 300 mm in length.

The total light transmittance and the diffusion transmittance of the sample were measured by a method according to JIS K 7136:2000, using a haze meter (NDH 7000SP, Nippon Denshoku Industries. Co., Ltd.) The measured values and the haze calculated therefrom (total light transmittance/diffusion transmittance×100) are shown in Table 2.

TABLE 2

| | Examples | | | | Comparative Examples | | |
|---|---|---|---|---|---|---|---|
| Items | 1 | 2 | 3 | 4 | 1 | 2 | 3 |
| Diffusion | 45.4 | 39.2 | 27.6 | 19.7 | 55.2 | 45.7 | 50.7 |
| transmittance [%] | | | | | | | |
| Wavelength conversion | 85 | 77 | 88 | 96 | 120 | 120 | 85 |
| layer thickness [μm] | | | | | | | |
| Haze [%] | 99.5 | 99.5 | 99.6 | 99.8 | 79.3 | 99.2 | 99.2 |
| Amount of phosphor | 3.62 | 3.24 | 2.92 | 2.42 | 4.61 | 4.14 | 4.05 |
| used [×10⁻² g/cm²] | | | | | | | |

As shown in Table 2, the wavelength conversion member of the Examples, satisfying that a diffusion transmittance was 50% or less and a thickness of the wavelength conversion layer was 100 μm, or that a light scattering material is included in an amount of 2.0% by mass or more with respect to the total wavelength conversion layer, the amount per unit area of the quantum dot phosphor at which the white point of the same grade was satisfied was smaller than that of the wavelength conversion member of the Comparative Examples. These results show that the wavelength conversion member of the Examples can achieve a desired color tone with a reduced amount of a phosphor.

All publications, patent applications, and technical standards mentioned in this specification are herein incorporated by reference to the same extent as if each individual publication, patent application, or technical standard was specifically and individually indicated to be incorporated by reference.

### EXPLANATION OF SYMBOLS

10: wavelength conversion member, 11: wavelength conversion layer, 12A: covering material, 12B: covering material, 20: backlight unit, 21: light source, 22: light guard plate, 23: retroreflection member, 24: reflection plate, 30: liquid crystal display device, 31: liquid crystal cell unit, 32: liquid crystal cell, 33A: polarization plate, 33B: polarization plate, L_{B}: blue light, F_{R}: red light, L_{G}: green light, L_{W}: white light

1. A wavelength conversion member, comprising a wavelength conversion layer that comprises a phosphor and a light scattering material, the wavelength conversion member having a diffusion transmittance of 50% or less, and the wavelength conversion layer having a thickness of 100 μm or less.

2. The wavelength conversion member according to claim 1, wherein a ratio of the diffusion transmittance with respect to a total light transmittance is 80% or more.

3. The wavelength conversion member according to claim 1, wherein the light scattering material comprises titanium oxide.

4. The wavelength conversion member according to claim 1, wherein a content of the light scattering material in the wavelength conversion layer is 2.0% by mass or more.

5. The wavelength conversion member according to claim 1, further comprising a resin cured product.

6. A wavelength conversion member, comprising a wavelength conversion layer that comprises a phosphor and a light scattering material, a content of the light scattering material in a total wavelength conversion layer being 2.0% by mass or more.

7. The wavelength conversion member according to claim 6, wherein the light scattering material comprises titanium oxide.

8. The wavelength conversion member according to claim 6, having a ratio of a diffusion transmittance with respect to a total light transmittance of 80% or more.

9. A backlight unit, comprising the wavelength conversion member according to claim 1, and a light source.

10. An image display device, comprising the backlight unit according to claim 9.
